(19) United States
(12) Patent Application Publication
(10) Pub. No.: US 2014/0247131 A1
(43) Pub. Date: Sep. 4, 2014

(54) DRIVE CARRIER TOUCH SENSING

(71) Applicants: Michael S. Bunker, Tomball, TX (US); Andrew James Phelan, Magnolia, TX (US); John P. Franz, Houston, TX (US)

(72) Inventors: Michael S. Bunker, Tomball, TX (US); Andrew James Phelan, Magnolia, TX (US); John P. Franz, Houston, TX (US)

(73) Assignee: Hewlett-Packard Company, Fort Collins, CO (US)

(21) Appl. No.: 14/349,117

(22) PCT Filed: Oct. 25, 2011
(86) PCT No.: PCT/US11/57586

§ 371 Date: Apr. 2, 2014

(51) Int. Cl. G08B 5/22

(52) U.S. Cl. CPC G08B 5/22
USPC 340/691.6

(57) ABSTRACT

A system includes a computing device with touch sensing capabilities and a sensor positioned on a drive carrier and electronically connected to the computing device. The computing device receives a sensor measurement and determines based on the sensor measurement if the sensor positioned on the drive carrier has been touched. The computing device conducts a process in response to a determination that the sensor positioned on the drive carrier has been touched.

### BACKGROUND

Today's data storage demands have created a need for systems that can store large amounts of data. To this end, chassis have been developed to accommodate a plurality of drives such as hard disk drives (HDD). Each of these drives is typically disposed within a drive carrier. Among other things, the drive carrier may serve to lock and hold the drive in a particular position within the chassis, and to protect the drive from electromagnetic energy interference (EMI) which may be caused by neighboring drives.

### BRIEF DESCRIPTION OF THE DRAWINGS

Example embodiments are described in the following detailed description and in reference to the drawings, in which:

FIG. 1 is a block diagram of a system in accordance with embodiments;

FIG. 2 is a process flow diagram of a method of operating a computing device in accordance with embodiments;

FIG. 3 is a block diagram showing a non-transitory, computer-readable medium that stores instructions for operating a computing device in accordance with embodiments;

FIG. 4 is a process flow diagram of a method of drive identification in accordance with embodiments;

FIG. 5 is a graphical representation of a system implementing a drive identification process in accordance with embodiments;

FIG. 6 is a process flow diagram of a method of drive configuration in accordance with embodiments;

FIG. 7 is a graphical representation of a system implementing a drive configuration process in accordance with embodiments;

FIG. 8 is graphical representation of device definition changes in accordance with embodiments; and

FIG. 9 is a graphical representation of a hybrid handle in accordance with embodiments.

### DETAILED DESCRIPTION

Disclosed are embodiments of a drive carrier with touch sensing capabilities. In one embodiment, a system comprises a computing device and a sensor. The sensor is positioned on a drive carrier and electronically connected to the computing device. The computing device polls the sensor or otherwise receives measurements from the sensor and determines based on a result if the sensor has been touched. In response to a determination that the sensor has been touched, the computing device conducts a process.

One such process involves outputting from the computing device a signal indicating that the sensor has been touched. This signal may be sent to a local or remote computing device to specify which particular drive carrier has been touched. For example, a technician proximate to a chassis can touch a sensor on a particular drive carrier and thereby cause a signal to be sent to a remote computer. The signal may indicate to a user associated with the remote computer, e.g., which drive the technician is about to remove or service. Similarly, a technician may touch a sensor on a drive carrier to, e.g., identify to a remote user a particular drive that is operating abnormally. This process may significantly simplify the task of identifying a particular drive within a chassis to another party, and further may reduce any ambiguity as to which drive is being identified. Prior systems did not include this drive identification mechanism, and therefore it was difficult to reliably and efficiently identify a drive or multiple drives within a chassis to another party.

Another process that may be initiated by the computing device involves outputting a configuration command. In particular, the computing device may issue a command to create a default logical drive in response to a determination that a sensor on the drive carrier has been touched. For example, a user may touch a sensor of a drive carrier and thereby cause the computing device to issue a command to configure the associated drive Redundant Array of Independent Disks 0 (RAID0). Similarly, the user may touch sensors of two drive carriers and thereby cause the computing device to issue a command to configure the associated drives, e.g., RAID1. Still further, the user may touch sensors of three or more drive carriers and thereby cause the computing device to issue a command to configure the associated drives, e.g., RAID5. Regardless of the type of configuration, such touch sensing capabilities allow efficient logical drive creation. This may reduce the need to have to create a logical drive at an associated server by, e.g., booting up the server, selecting a specific controller, selecting drives to add to an array, and selecting a logical drive type (e.g., RAID0, RAID1, etc.). Additionally, this may reduce the need to have to employ a “crash cart” at the server, due to the fact that many servers are deployed without a mouse or keyboard. Still further, this may reduce any ambiguity as to which physical drives are selected or intended for the configuration.

A further process that may be conducted by the computing device involves changing or toggling device definitions. For example, a light source associated with the device carrier may initially have a first definition (e.g., power on/off). By touching the sensor, a user may change the definition associated with the light source to a second, third, fourth, etc. definition (e.g., error, link rate, dual domain, disk soft errors, link errors, etc.). Hence, the user may use the touch sensing capabilities of the drive carrier to toggle to a different set of definitions for a light source and thereby obtain additional information. This may significantly increase the amount of information that the drive carrier provides via light sources.

Another process that may be conducted by the computing device in response to a sensor touch involves providing an early drive removal indication to another device. In particular, the sensor may comprise an eject button. When a user touches the eject button, the computing device may detect this touch via the sensor and provide an early indication to other devices (e.g., controllers, host bus adapters (HBA), expanders, etc.) that the drive is about to be removed. As a result, the other devices may log and/or prepare for the drive removal in advance, as opposed to learning that a drive has been removed after the fact.

A further process that may be executed by the computing device in response to sensor touch involves storing information about the touch in memory. For example, after a touch is sensed, the computing device may communicate with an internal or associated memory to log the touch in a drive carrier touch log. This log may be accessible to determine if or when a drive carrier was touched. This may help reduce disputes as to whether a particular drive was touched prior to a failure, or may help determine the cause of a failure.

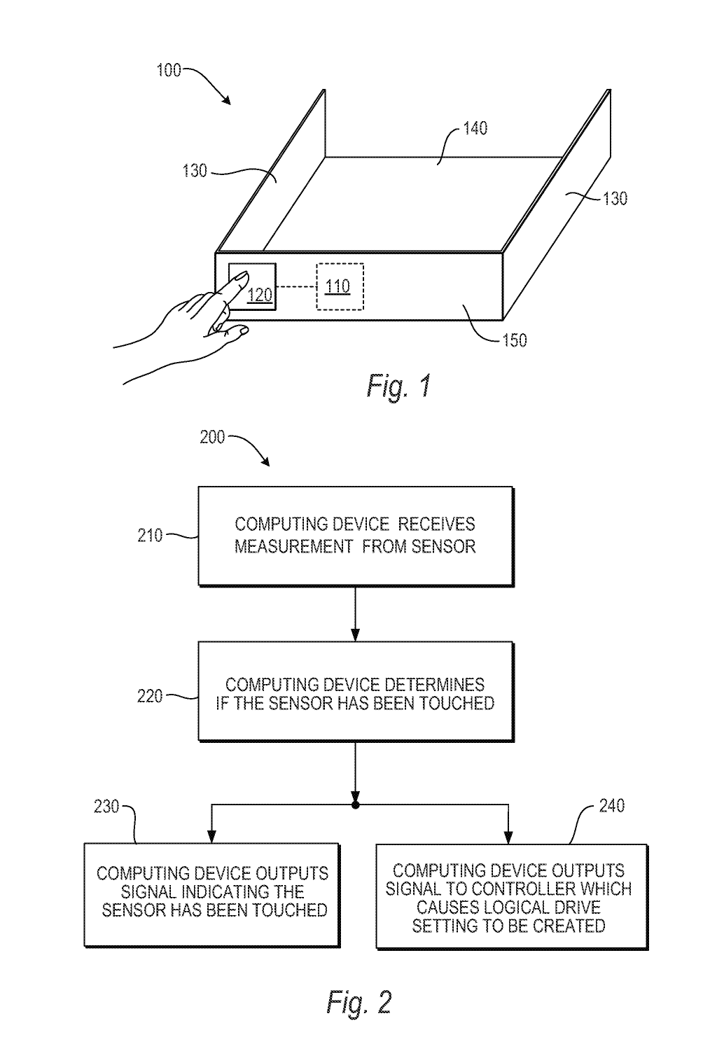

FIG. 1 is a block diagram of a system in accordance with embodiments. A drive carrier 100 may include a computing device 110 and a sensor 120. These devices may be disposed on a rigid or flexible printed circuit board affixed or disposed within the drive carrier 100. In an alternate embodiment, the computing device 110 may be located off the drive carrier 100. For example, the computing device 110 may be located on a backplane or on an array controller.

The drive carrier 100 may be constructed of plastic, metal, and/or other materials. It may include opposing sidewalls 130, a floor 140, and a front plate or bezel 150. A drive such as a hard disk drive (HDD), solid state drive (SSD), or hybrid drive may be placed within the area formed by the opposing sidewalls 130, floor 140, and front plate 150. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed filed. Other types of drives such as flash-based SSDs, enterprise flash drives (EFDs), etc. may also be used with the drive carrier.

The computing device 110 may be a microcontroller, microprocessor, and/or processor with touch sensing capability. The computing device 110 may be located on the drive carrier 100 or externally on a backplane or as part of an array controller. The computing device 110 may use its touch sensing capability to detect brief sensor touches (e.g., 0.01 seconds), longer sensor touches (3 seconds), and/or sensor swipes. The type of touch detected and the requirements of the touch (e.g., time, direction, etc.) may be programmable via software and/or hardware. The type of touch detected and the requirement of the touch may also be pre-programmed as a factory setting.

The sensor 120 may be a capacitive sensor, an inductive sensor, or other type of touch sensor. Capacitive touch sensing is based on capacitive coupling and uses capacitive sensors to detect and measure proximity, position, displacement, acceleration, etc. The technology detects anything which is conductive or has a dielectric different than that of the air. More specifically, a capacitor is created comprising two electronically isolated conductors that are arranged in close proximity to one another. The conductors can be wires, traces, conductive plates, insulators coated with a conductive layer, etc. The introduction of a user's fingers to or near a conductor and/or to an element electronically coupled to the conductor (e.g., a handle, button, etc.) produces an increase in capacitance that is detected by the computing device 110. Inductive touch sensing, on the other hand, is based on inductive coupling and uses inductive sensors to detect touches. More specifically, the technology detects impedance changes caused by a shift in, e.g., a handle, button, or other portion of the drive carrier. This shift may be attributed to a user's finger coming into contact with the handle, button, or other portion of the drive carrier.

In some embodiments, the sensor may comprise a momentary switch such as a push-button device. The computing device 110 may react to the button being pushed (e.g., for a brief time period or for an extended time period) and thereby cause various processes discussed herein to be initiated (e.g., drive identification, drive configuration, changing device definitions, early drive removal indication, touch logging, etc.).

In embodiments, the sensor 120 may comprise a handle, button, or any other portion on the exterior of the drive carrier. The handle, button, or portion on the exterior of the drive carrier may serve as a conductor that when touched varies a measured, capacitance, inductance, resistance, and/or voltage.

Regardless of the type of sensor 120 and implementation, the computing device 110 may be configured to periodically or continuously poll the sensor 120 or otherwise receive sensor measurements and, based on the result, determine if the sensor has been touched. Stated differently, the computing device 110 may be configured to detect that a portion on the exterior of the hard drive carrier has been touched via the sensor. If the computing device 110 determines that a touch has occurred, the computing device may be configured to execute at least the processes described in detail below with reference to FIGS. 4-10.

FIG. 2 is a process flow diagram of a method in accordance with embodiments. The method 200 may be performed by computing device 110 in FIG. 1, and may involve sensor 120 of FIG. 1. Drive carrier 100 in FIG. 1 may include both the computing device 110 and the sensor 120.

The method may begin at block 210, wherein the computing device polls or otherwise receives measurements from the sensor 120. This polling may be continuous or periodic, and may measure capacitance, inductance, resistance, and/or voltage. At block 220, the computing device determines, based on the measurement result, whether or not the sensor 120 has been touched. In response to a determination that the sensor has been touched, the computing device conducts a process. This process may involve, at block 230, outputting a signal to a second computing device, the signal indicating that the sensor has been touched. Alternatively or in addition, at block 240, the process may involve outputting a signal to a controller which causes the controller to create a logical drive setting. These processes as well as further processes are described further below with reference to FIGS. 4-10.

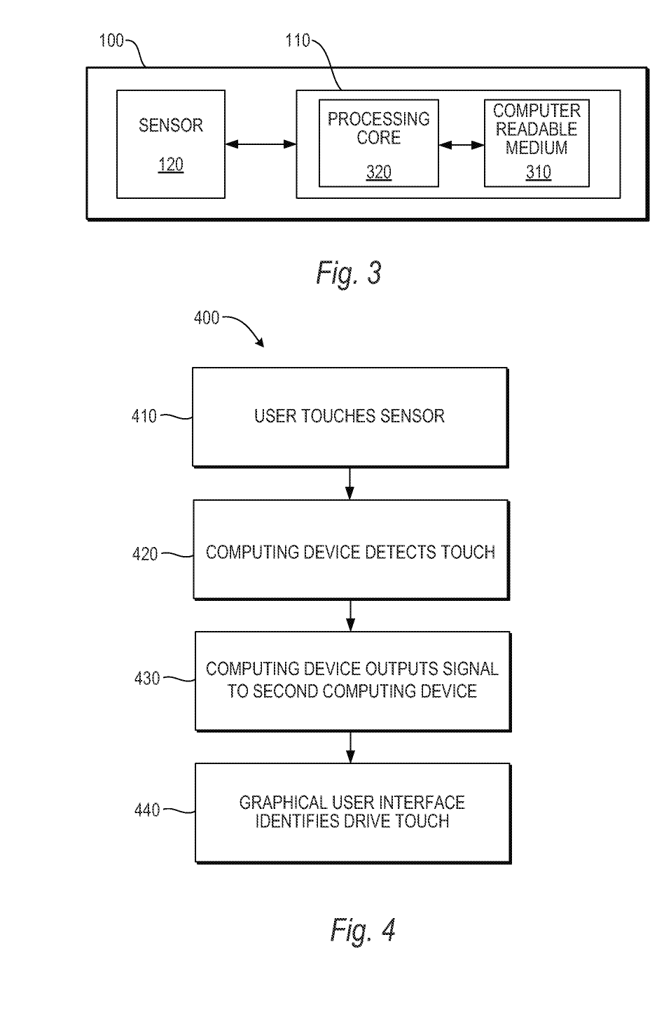

FIG. 3 is a block diagram showing a non-transitory, computer-readable medium having computer-executable instructions stored thereon in accordance with embodiments. The non-transitory, computer-readable medium is generally referred to by the reference number 310 and may be included in computing device 110 of drive carrier 100 described in relation to FIG. 1. The non-transitory computer-readable medium 310 may correspond to any typical storage device that stores computer-implemented instructions, such as programming code or the like. For example, the non-transitory computer-readable medium 310 may include one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical devices, and flash memory devices.

A processing core 320 generally retrieves and executes the instructions stored in the non-transitory, computer-readable medium 310 to operate the computing device 110. In embodiments, the instructions, upon execution, may cause the computing device 110 to poll sensor 120 or receive measurements from sensor 120 and determine based on the result if sensor 120 has been touched. The instructions, upon execution, may also cause the computing device 110 to determine if sensor 120 has been continuously touched for at least a predeterminable time period (e.g., 3 seconds). If sensor 120 has been touched for at least the predeterminable time period, the instructions, upon execution, may also cause the computing device 110 to conduct a first process. The first process may comprise transmitting a signal to a controller which causes the controller to create a logical drive setting, as described in more detail below. Alternatively, if sensor 120 has been touched, but not for the predeterminable time period (e.g., 3 seconds), the instructions, upon execution, may also cause the computing device 110 to conduct a second process. This second process may comprise transmitting a drive locate signal to a remote computing device, as described in greater detail below.

As described in the foregoing, the computing device 110 of the drive carrier 100 may cause various processes to be executed in response to a determination that the sensor 120 has been touched. Below is a further description of each process. It should be understood that these processes are examples and other processes or variations could also be conducted. It should also be understood that these processes are not mutually exclusive, and multiple processes could be triggered in response to a determination that the sensor 120 has been touched.

### Drive Identification

Embodiments enable a user to utilize the above-discussed touch sensing capabilities to identify a drive to another user. FIG. 4 is a process flow diagram of a method 400 in accordance with embodiments describing this drive identification process. The method may begin at block 410, where a user touches sensor 120. The user may briefly touch the sensor 120, or, alternatively, touch-and-hold the sensor for a predeterminable time period (e.g., 3 seconds). Further, the user may swipe the sensor 120. At block 420, the computing device 110 detects the touch. At block 430, the computing device 110 may output a signal to a second computing device (e.g., a local or remote computer). At block 440, this signal may directly or indirectly cause a graphical user interface (GUI) associated with a the second computing device to identify which drive carrier is being touched. This second computing device may be, e.g., a server, desktop, laptop, hand held device, smartphone, tablet, etc. located proximate to the drive carrier (e.g., in the same room) or remote from the drive carrier (e.g., in a different facility or state). In some embodiments, the signal output from the computing device 110 may directly or indirectly cause multiple GUIs associated with multiple computing devices (remote and/or local) to identify which drive carrier is being touched

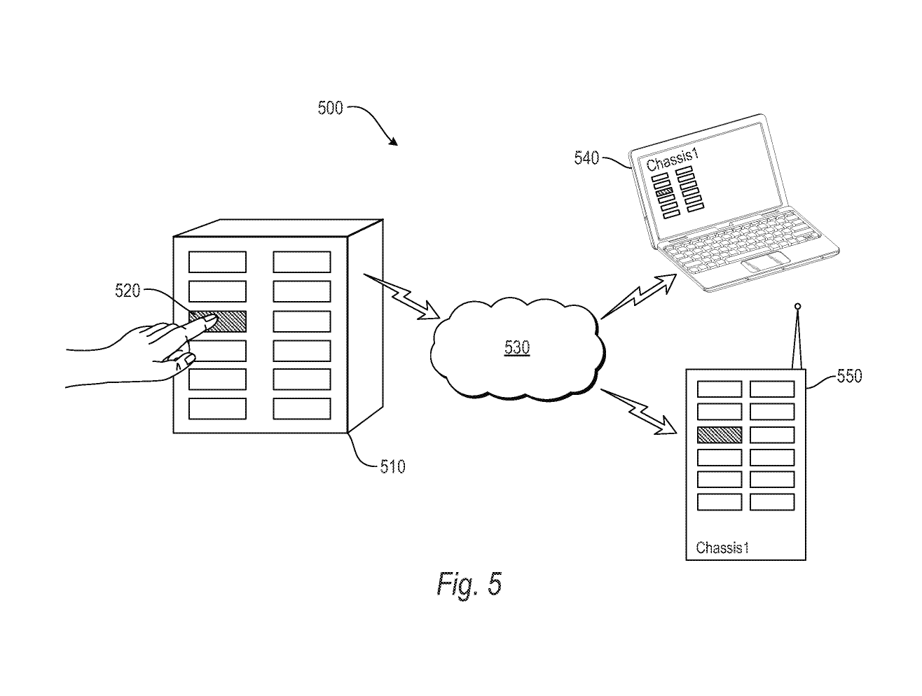

FIG. 5 is a graphical representation of a system 500 implementing the drive identification process in accordance with embodiments. The system comprises a chassis 510 including a plurality of drives. If a user desires to identify a particular drive 520 to another party or parties for, e.g., troubleshooting, failure reporting, replacement, or other purposes, the user may touch a sensor 120 on a particular drive carrier 520. Depending on the settings of the associated computing device 110, this may be a brief touch, a touch-and-hold for a predeterminable time period, or a swipe. This action causes the computing device 110 resident on the particular drive carrier 520 to output a signal. The signal may propagate via communication network 530 to a remote or local computing device. As shown, the remote or local computing device may be a laptop 540 or a hand held computer 550. Further, the remote or local computing device may be a server, disk array, personal computer, or any other type of computing device configured to receive and/or provide data to an associated user.

Communication network 530 may be any type of communication network/bus/path, including, but not limited to, wired/wireless networks, local area networks (LANs), wide area network (WANs), telecommunication networks, the Internet, computer networks, Bluetooth networks, Ethernet LANs, token ring LANs, Inter-Integrated Circuit (I²C), serial advanced technology attachment (SATA), and/or serial attached SCSI (SAS).

This drive identification process enables efficient and unambiguous identification of a drive. This may eliminate the risk associated with identifying a drive via voice or other types of communication that inevitably introduce human error. Moreover, this may enable drive errors/failures to be identified and rectified in a shorter time period.

Drive Configuration

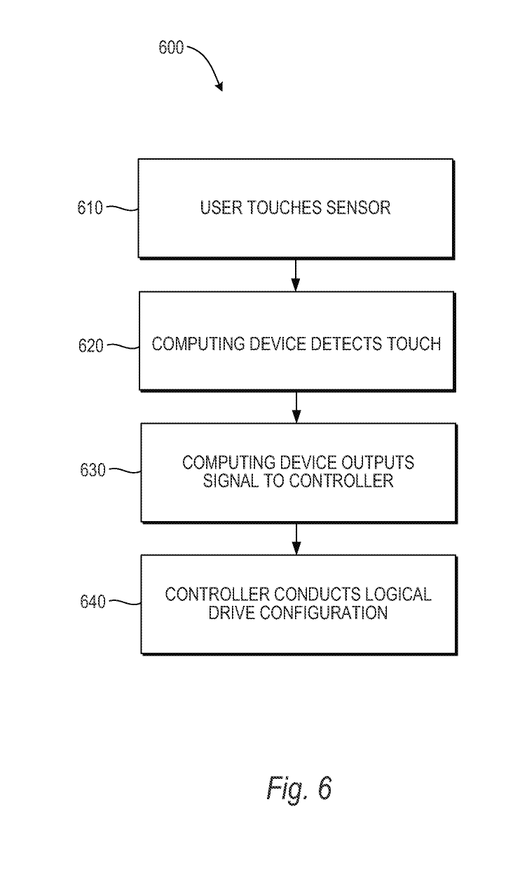

Embodiments enable a user to employ the above-discussed drive carrier touch sensing capabilities to configure a drive or multiple drives. FIG. 6 is a process flow diagram of a method 600 in accordance with embodiments describing this drive configuration process. The process may be used to logically configure previously unconfigured drives in an efficient manner. This may reduce the need have to create a logical drive at a server by, e.g., booting up the server, selecting a controller, selecting drives to add to an array, and selecting a logical drive type (e.g., RAID0, RAID1, etc.). Additionally, this may reduce the need to have to employ a “crash cart” at the server, since many servers are deployed without a mouse or keyboard. Still further, this may reduce any ambiguity as to which physical drives are selected for the configuration.

The method may begin at block 610, where the user touches sensor 120. The user may briefly touch the sensor 120, or, depending on settings, touch-and-hold sensor 120 for a predeterminable time period (e.g., 2 seconds). Further, the user may swipe the sensor. At block 620, the computing device 110 detects the touch. At block 630, the computing device 110 outputs a signal to a controller, e.g., a RAID controller. At block 640, the controller conducts a logical drive configuration based on the received signal.

The controller may logically configure the drive to a default setting. In embodiments, this may comprise a RAID configuration (e.g., RAID0, RAID1, RAID2, RAID3, RAID4, RAID5, RAID6, etc.) For example, if the user touches one drive, the controller may configure the drive RAID0. If the user touches two drives, the controller may configure the drives RAID1. If the user touches three or more drives, the controller may configure each drive RAID5. Other and/or similar types of potential configurations may include RAID7, RAID10, RAIDS, RAID-Z, RAID-DP, RAID-TP, v RAID, RAIDIE, nested (hybrid) RAID, advanced data guarding (ADG), failure-resistance disk systems (FRDS), failure-tolerant disk systems (FTDS), and/or disaster-tolerant disk systems (DTDS).

In the case of multiple drive configuration, the user may have to touch each drive within a predeterminable time period (e.g., 10 seconds). Alternatively, the user may have to touch each drive simultaneously. Still further, the user may have to touch each drive after a triggering event.

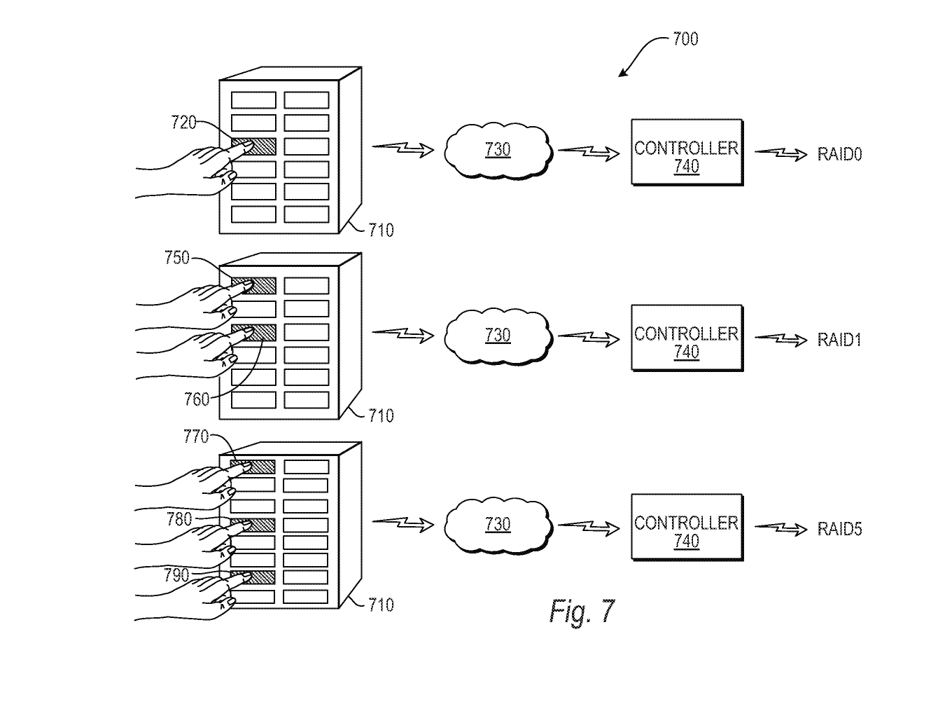

FIG. 7 is a graphical representation of a system 700 implementing the drive configuration process in accordance with embodiments. The system comprises a chassis 710 which includes a plurality of drives, a communication network 730, and a controller 740 (e.g., a RAID controller). When a user touches a sensor associated with one drive carrier 720, the computing device 110 resident on the drive carrier detects this touch and outputs a signal over communication network 730 to controller 740. This signal may cause, e.g., a RAID0 configuration. When a user touches a sensor associated with a first drive carrier 750 and a second drive carrier 760, the computing device 110 resident on the drive carrier detects this touch and outputs a signal or multiple signals over communication network 730 to controller 740. This signal may cause, e.g., a RAID1 configuration. When a user touches a sensor associated with a first drive carrier 770, a second drive carrier 780, and a third drive carrier 790, the computing device 110 resident on the drive carrier detects this touch and outputs a signal or multiple signals over communication network 730 to controller 740, which subsequently configures the drive, e.g., RAID5.

As mentioned above, communication network 730 may be any type of communication network/bus/path, including, but not limited to, wired/wireless networks, local area networks (LANs), wide area network (WANs), telecommunication networks, the Internet, computer networks, Bluetooth networks, Ethernet LANs, token ring LANs, Inter-Integrated Circuit (I²C), serial advanced technology attachment (SATA), and/or serial attached SCSI (SAS).

As also mentioned, controller 740 may be a RAID controller or any other type of disk array controller.

### Changing Device Definitions

Embodiments enable a user to utilize the above-discussed drive carrier touch sensing capabilities to change device definitions. The user may touch a sensor 120 and thereby change a definition associated with, e.g., a light source or a plurality of light sources. For instance, a light source associated with the device carrier (e.g., a LED) may initially have a first definition (e.g., power on/off). By touching the sensor 120, a user may change the definition associated with the light source to a second definition (e.g., error). Thus, the sensor touch may cause the definition associated with the light source to toggle. This enables a light source to provide additional information such as active, inactive, failure, error, power-on, power-off, and/or standby.

The light source may also toggle to indicate if dual domain or dual path is active. These architectures create redundant pathways from servers to a storage device, thereby reducing single point of failure within the storage network. This makes it possible to tolerate host bus adapter (HBA) failure, external cable failure, expander failure, failure in a spanned disk (JBOD) environment, and failure in RAID environments.

The light source may further toggle to indicate a soft error, a hard error, a firm error, and/or a DWORD error. Soft disk errors are errors in the data written to the disk (i.e., the data written to the disk has become corrupt). Hard disk errors are errors in the drive itself. This may constitute physical or electrical failures that require the drive to be replaced or repaired. Firm disk errors are errors that are physical issues on the magnetic media of the hard disk that can be repaired via software. DWORD errors are link errors.

The light source may also toggle to indicate the link rate. In particular, one or more light sources may indicate link rate by varying intensity and/or color.

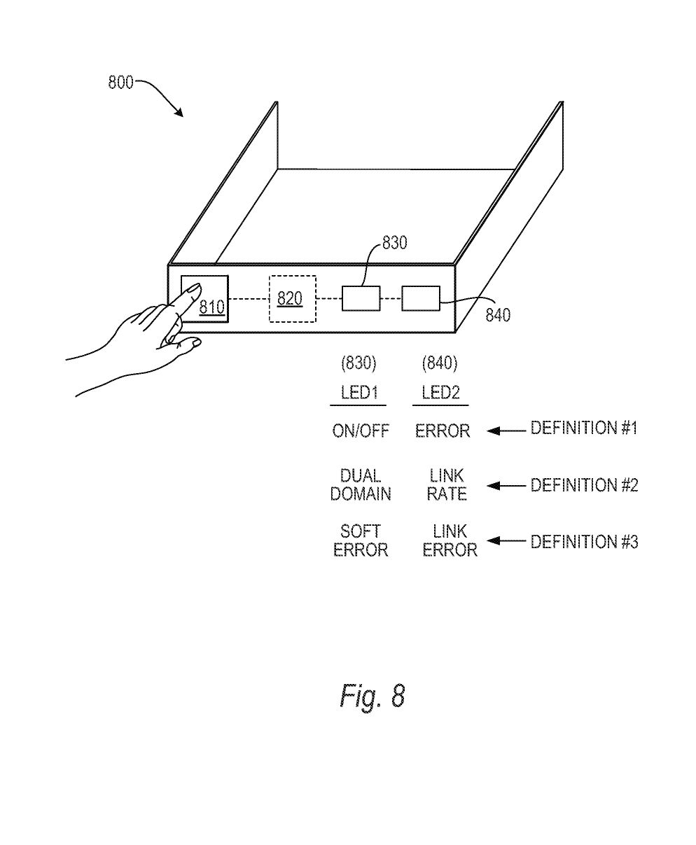

FIG. 8 is graphical representation of a device definition change with respect to light sources on a drive carrier 800 in accordance with embodiments. As illustrated, a user may touch a sensor 810 on the drive carrier 800. The sensor 810 may comprise a specific point, button, and/or handle on the drive carrier 800. The touch may be brief or may last a specific time period. The computing device 820 may sense this touch and cause the definitions associated with lights sources 830 and 840 to toggle. For instance, the first light source 830 may toggle between providing an on/off indication (definition #1), a dual domain indication (definition #2), and a disk soft error indication (definition #3). Similarly, the second light source 840 may toggle between providing an error indication (definition #1), a link rate indication (definition #2), and a link error indication (definition #3).

In embodiments, the sensor 810 may be used to toggle all light sources to a second, third, fourth, etc. definition. Alternatively, in embodiments, the sensor may be used to toggle a single or selected light sources to a second, third, fourth, etc. definition.

It should be understood that the definition of any type of indicator may be toggled, including, but not limited to, light emitting devices (LEDs), displays, GUIs, etc.

### Early Drive Removal Indication

Embodiments employ the above-discussed touch sensing capabilities to provide an early warning of drive removal. Specifically, a sensor 120 may comprise an eject button associated with the drive carrier. When a user touches or depresses the eject button, the computing device 110 may detect this touch and provide an early warning indication to other devices before the drive is actually ejected. For instance, the computing device may alert other devices that the drive will be ejected 500 mS before the drive is actually ejected. This may enable devices such as controllers, host bus adapters (HBA), expanders, and/or remote computers to log and/or prepare for the drive removal in advance, as opposed to learning that a drive has been removed after the fact.

### Touch Logging

Embodiments provide for logging or recording of sensor touches in memory. In particular, computing device 110 may detect that sensor 120 is touched and store information such as the date, time, and location of the touch in an internal or external memory. The internal or external memory may comprise EEPROM, RAM, ROM, SRAM, DRAM, NVRAM, and/or flash memory. This log function may be helpful for data analysis, dispute resolution, and/or debugging. For example, the log may be analyzed to determine the frequency and/or type or device carrier touches. Alternatively or in addition, the log may be analyzed to determine whether or not a drive carrier was touched prior to a failure. This may be helpful in a situation where there is a dispute as to whether a drive was touched and/or what caused a failure. Furthermore, the log may be helpful for debugging by helping to narrow potential causes of an error/failure.

The touch log may be accessible from a computing device directly connected to the chassis including the drive carrier, a computing device in close proximity to the chassis, or a computing device in a remote location. Regardless of the location of the computing device, data such a time, date, location, drive carrier identification number, and/or chassis number may be accessed.

The touch log may also record the type of touch. For example, the touch log may record if the touch was brief touch (e.g., 0.01 seconds), an extended touch (e.g., 3 seconds), and/or a swipe (top-to-bottom, bottom-to-top, left-to-right, right-to-left, and/or diagonal). Each of these types of touches may be associated with one of the different processes described herein. For example, a brief touch may initiate the above-mentioned drive identification process. An extended touch may initiate the above-mentioned drive configuration process. A swipe may initiate the above-described device definition change. Further, a different process may be associated with each type of swipe (top-to-bottom, bottom-to-top, left-to-right, right-to-left, and/or diagonal).

### Handle Release

Embodiments provide for releasing a handle associated with the drive carrier in response to a drive carrier touch. Specifically, the computing device 110 is configured to detect a touch on a sensor 120. This sensor may comprise a handle, a button, or another point on the drive carrier. In response to an appropriate touch, the computing device may cause a latched, closed, and/or locked handle to unlock and/or release, thereby enabling a user to remove the drive from the chassis. The release mechanism may be an electro-mechanical release mechanism such as electro-magnetic release mechanism.

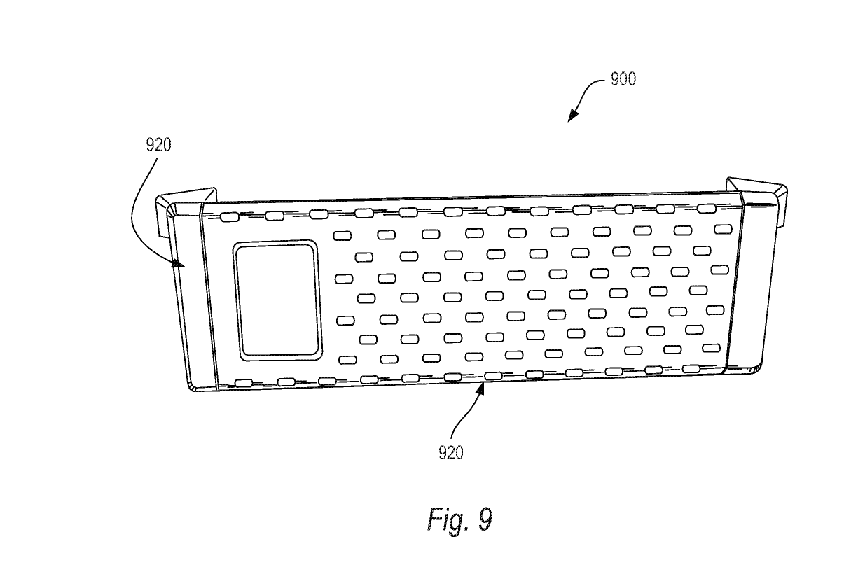

In some embodiments, the handle may be plastic, metal, or a hybrid drive carrier handle formed of plastic and metal. A hybrid handle provides added strength when compared to a pure plastic handle due to the additional metal (e.g., stainless steel). The hybrid handle is also lower cost than a pure metal handle due to its incorporation of plastic. The metal part may affixed to the plastic via snap-fit, adhesive, and/or a fastener. FIG. 9 provides a graphical representation of the hybrid handle 900. As shown, the handle 900 comprises a plastic portion 910 and a metal portion 920. This metal portion may provide addition strength over a pure plastic handle, but at a lower cost than a cast metal handle. Further, the metal portion of the handle may form a portion of the sensor. In embodiments, the metal plate on the handle may be electronically connected to a metal contact pad integrated on a printed circuit assembly, flex cable, and/or printed circuit board. This connection may be made via, e.g., a conductor such as a spring. When a user touches the handle, the computing device 110 uses, e.g., an internal analog-to-digital converter (ADC) to detect a voltage change. A change in voltage from an average operating point may signify a touch and is acted upon in one of the various manners described in this disclosure.

### Drive Release

Embodiments also provide for releasing the drive associated with the drive carrier in response to a touch. In particular, the computing device 110 is configured to detect a touch on to sensor 120 and cause the hard drive carrier 100 with associated hard drive to release from the chassis. The release mechanism may be an electro-mechanical release mechanism such as an electro-magnetic release mechanism. The drive may be released immediately after detection of a touch, or after a predeterminable time period. In some embodiments, the drive may be released only after processes associated with the drive are complete.

What is claimed is:

1. A system comprising:
a computing device with touch sensing capabilities; and
a sensor positioned on a drive carrier and electronically connected to the computing device,
wherein the computing device is to receive a sensor measurement and determine based on the sensor measurement if the sensor positioned on the drive carrier has been touched; and
wherein the computing device is to conduct a process in response to a determination that the sensor positioned on the drive carrier has been touched.

2. The system of claim 1, wherein the process comprises to output a signal to a second computing device, the signal indicating that the sensor positioned on the drive carrier has been touched.

3. The system of claim 1, wherein the computing device is to determine if the sensor positioned on the drive carrier has been touched for a time period.

4. The system of claim 1, wherein the process comprises to create a logical drive setting.

5. The system of claim 1, wherein the process comprises to change a definition associated with a light source.

6. The system of claim 1, wherein the computing device is to store information to a memory each time the sensor positioned on the drive carrier has been touched.

7. The system of claim 1, wherein the process comprises to indicate to a second computing device that a drive attached to the drive carrier will be removed in the future.

8. The system of claim 1, wherein the process comprises to transmit a signal to an electro-mechanical release mechanism which causes the electro-mechanical release mechanism to release a handle or release a drive attached to the drive carrier from a chassis.

9. The system of claim 1, wherein the drive carrier comprises a plastic handle with a metal portion attached to the surface of the plastic handle, and wherein the sensor comprises the metal portion.

10. The system of claim 1, wherein the computing device comprises a microcontroller positioned on the drive carrier.

11. A method comprising:
receiving a measurement obtained by a sensor at a computing device, wherein the computing device and the sensor are part of a drive carrier;
determining, based on the measurement, if the sensor has been touched;
in response to a determination that the sensor has been touched, conducting a process, wherein the process comprises:
outputting a signal to a second computing device, the signal indicating that the sensor has been touched; or
outputting a signal to a controller which causes the controller to create a logical drive setting.

12. The method of claim 11, further comprising determining if the sensor has been touched for a time period.

13. A non-transitory computer-readable medium having computer-executable instructions stored thereon that when executed causes a computing device to:
receive a measurement obtained by a sensor positioned on a drive carrier and determine based on the measurement if the sensor positioned on the drive carrier has been touched;
determine if the sensor positioned on the drive carrier has been touched for at least a time period; and
if the sensor positioned on the drive carrier has been touched for at least the time period, conduct a first process, or, if the sensor positioned on the drive carrier has been touched but not for at least the time period, conduct a second process.

14. The non-transitory computer-readable medium of claim 13, wherein the first process comprises instructions to transmit a signal to a controller which causes the controller to create a logical drive setting.

15. The non-transitory computer-readable medium of claim 13, wherein the second process comprises instructions to output a drive locate signal to a remote computing device.
